(19) United States
(12) Patent Application Publication
(10) Pub. No.: US 2009/0313560 A1
(43) Pub. Date: Dec. 17, 2009

(54) FIELD DATA DISPLAY APPARATUS AND METHOD FOR DISPLAYING FIELD DATA

(75) Inventors: Takayuki Taketomi, Tokyo (JP); Masaaki Goto, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/481,885

(22) Filed: Jun. 10, 2009

(30) Foreign Application Priority Data
Jun. 12, 2008 (JP) 2008-153888

(51) Int. Cl. G06F 3/00

(52) U.S. Cl. 715/761

(57) ABSTRACT

There are provided a field data display apparatus capable of flexibly coping with field data elements differing in collection period from each other, and a method for displaying the field data. A trend data collection server collects field data elements from control stations, in predetermined periods, respectively, to be stored as trend data elements corresponding to tag names, respectively, in a trend data storage. A display unit displays selected trend data elements selected by a selective operation acceptance unit on a display screen. The selective operation acceptance unit accepts an operation for selecting trend data elements, the trend data elements each having a plurality of collection periods differing from each other, mixedly present in the collection period of the field data element.

### FIELD OF THE INVENTION

The present invention relates to a field data display apparatus for displaying a plurality of field data elements on the same trend screen, and a method for displaying field data.

### BACKGROUND OF THE INVENTION

As for a field control system, there has since been developed a system wherein field data elements are collected in real time, and the field data elements collected are displayed as a trend data element in the form of a graph on a screen. The trend data element can be allocated to individual pens, and plural kinds of the trend data elements can be displayed on the same screen by concurrently using a plurality of the pens. Meanwhile, a collection period of each of the field data elements is preset by an engineering work.
[Patent Document 1] JP 2005-208698 A

### SUMMARY OF THE INVENTION

A conventional system, however, has had a drawback in that field data elements differing in collection period from each other cannot be displayed on the same trend screen, and cannot be handled in block as display data. Accordingly, there is a high hope for development of a system wherein optional trend data elements of which an operator wants to effect parallel-display can be displayed on the same screen to thereby handle display data in block. Further, with an operation at the time of allocating trend data elements to pens, respectively, enhancement in operability is hoped for.

It is therefore an object of the invention to provide a field data display apparatus capable of flexibly coping with field data elements differing in collection period from each other, and a method for displaying the field data.

A field data display apparatus according to the present invention, in its one aspect, is a field data display apparatus for displaying a plurality of field data elements on the same trend screen, said apparatus comprising storage means for collecting field data elements in predetermined periods, respectively, to be stored as a trend data element, selective operation acceptance means for accepting an operation for selecting a plurality of trend data elements from among the trend data elements stored in the storage means, and display means for displaying the plurality of the trend data elements as selected through the intermediary of the selective operation acceptance means on the same trend screen, wherein the selective operation acceptance means accepts an operation for selecting trend data elements, the trend data elements each having a plurality of collection periods differing from each other, mixedly present in the collection period of the field data element.

With the field data display apparatus, an operation for selecting trend data elements, the trend data elements each having a plurality of collection periods differing from each other, mixedly present in the collection period of the field data element, is accepted, and a plurality of the trend data elements as selected are displayed on the same trend screen, so that it is possible to freely combine the field data elements having different collection periods with each other to thereby effect trend display.

The selective operation acceptance means may accept an operation for classifying the trend data elements on a period-by-period basis to be displayed on a screen, the operation being executed on the screen.

The field data display apparatus may further comprise pen-allocation information memory means for storing the plurality of the trend data elements as selected through the intermediary of the selective operation acceptance means, in reusable state.

The field data display apparatus may comprise display data memory means for storing display data elements on a screen, displayed by the display means, in a state as to be re-displayed by the display means.

A method for displaying field data, according to the present invention, in its another aspect, is a method for displaying a plurality of field data elements on the same trend screen, said method comprising the step of collecting field data elements in predetermined periods, respectively, to be stored as a trend data element, the step of accepting an operation for selecting a plurality of trend data elements from among the trend data elements stored in the preceding step for storing, and the step of displaying the plurality of the trend data elements as selected through the intermediary of the step of accepting the operation, on the same trend screen, wherein an operation for selecting trend data elements, the trend data elements each having a plurality of collection periods differing from each other, mixedly present in the collection period of the field data element, is accepted.

With the method for displaying field data, the operation for selecting trend data elements, the trend data elements each having a plurality of collection periods differing from each other, mixedly present in the collection period of the field data element, is accepted, and the plurality of the trend data elements as selected are displayed on the same trend screen, so that it is possible to freely combine the field data elements having different collection periods with each other to thereby effect trend display.

With the field data display apparatus according to the invention, the operation for selecting trend data elements, the trend data elements each having a plurality of collection periods differing from each other, mixedly present in the collection period of the field data element, is accepted, and the plurality of the trend data elements as selected are displayed on the same trend screen, so that it is possible to freely combine the field data elements having different collection periods with each other to thereby effect trend display.

With the method for displaying field data, according to the invention, the operation for selecting trend data elements, the trend data elements each having a plurality of collection periods differing from each other, mixedly present in the collection period of the field data element, is accepted, and the plurality of the trend data elements as selected are displayed on the same trend screen, so that it is possible to freely combine the field data elements having different collection periods with each other to thereby effect trend display.

### BRIEF DESCRIPTION OF THE DRAWINGS

FIG. 1 is a block diagram showing a configuration of a field control system wherein the field data display apparatus according to the present embodiment is used;

FIGS. 2(A) to 2(E) are flow charts each showing an operation of an operation-monitor station;

FIG. 3 is a view showing a trend screen;

FIG. 4 is a view showing a launcher screen;

FIG. 5 is a view showing the pen-allocation change screen; and

FIGS. 6(A), and 6(B) are views showing data makeup, in which FIG. 6(A) is a view showing data makeup of pen-allocation information, and FIG. 6(B) is a view showing data makeup of display data.

### DETAILED DESCRIPTION OF THE PREFERRED EMBODIMENTS

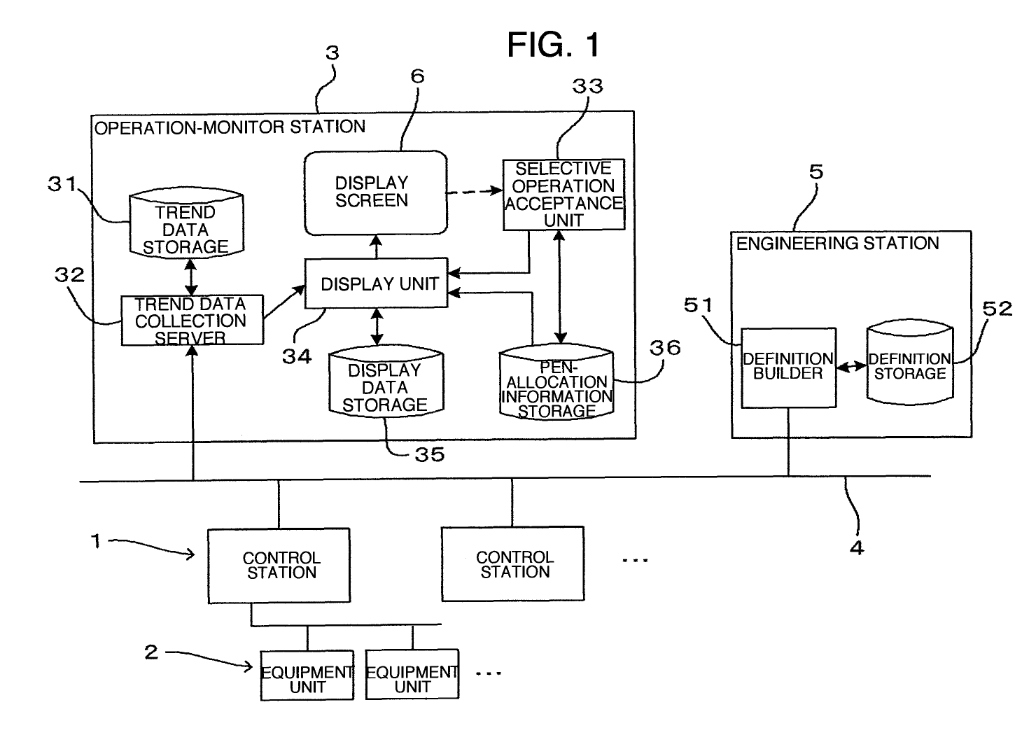

One embodiment of a field data display apparatus according to the invention is described hereinafter with reference to FIGS. 1 to 6.

FIG. 1 is a block diagram showing a configuration of a field control system wherein the field data display apparatus according to the present embodiment is used.

As shown in FIG. 1, the field control system comprises control stations 1, 1, . . . , dispersedly disposed within a plant, and an operation-monitor station 3 for comprehensively operating and monitoring field equipment units 2, 2, . . . , via the control stations 1, 1, . . . , respectively. Further, an engineering station 5 is connected to a network 4 connecting the operation-monitor station 3 to the control stations 1, 1, . . . , respectively.

The operation-monitor station 3 is the field data display apparatus according to the present embodiment.

As shown in FIG. 1, the operation-monitor station 3 comprises a trend data collection server 32 for collecting field data elements from the control stations 1, 1, . . . , in predetermined periods, respectively, to be stored as trend data elements corresponding to tag names, respectively, in a trend data storage 31, a selective operation acceptance unit 33 for accepting an operation for selecting the trend data elements as display targets, a display unit 34 for displaying selected trend data elements on a display screen 6, a display data storage 35 for storing display data elements displayed on the display screen 6, and a pen-allocation information storage 36 for storing pen-allocation information prepared based on an operation for the selective operation acceptance unit 33.

The trend data storage 31 corresponds to storage means, the display unit 34 display means, the selective operation acceptance unit 33 selective operation acceptance means, the display data storage 35 display data memory means, and the pen-allocation information storage 36 pen-allocation information memory means, respectively.

Meanwhile, the engineering station 5 is provided with a definition builder 51 for defining a method for collecting field data elements in such a way as to correspond to tag names and collection periods, respectively, and a definition storage 52 for storing definitions prepared by the definition builder 51.

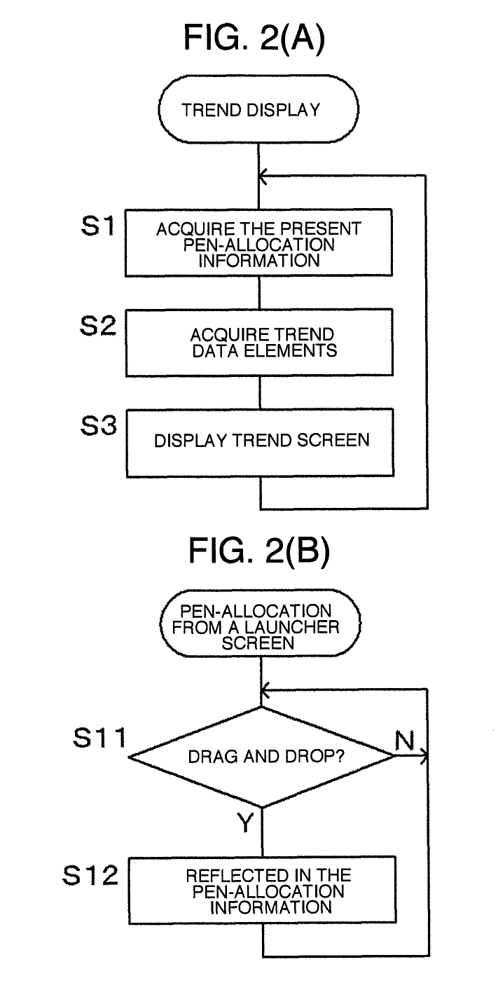

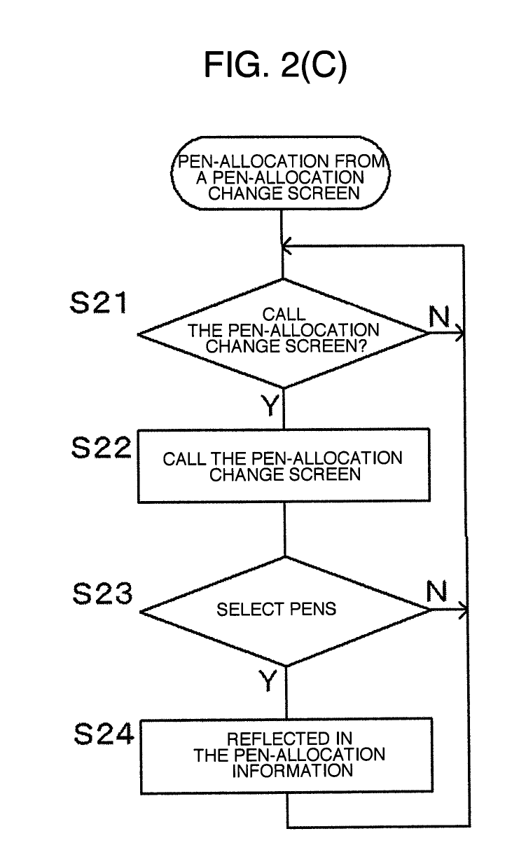

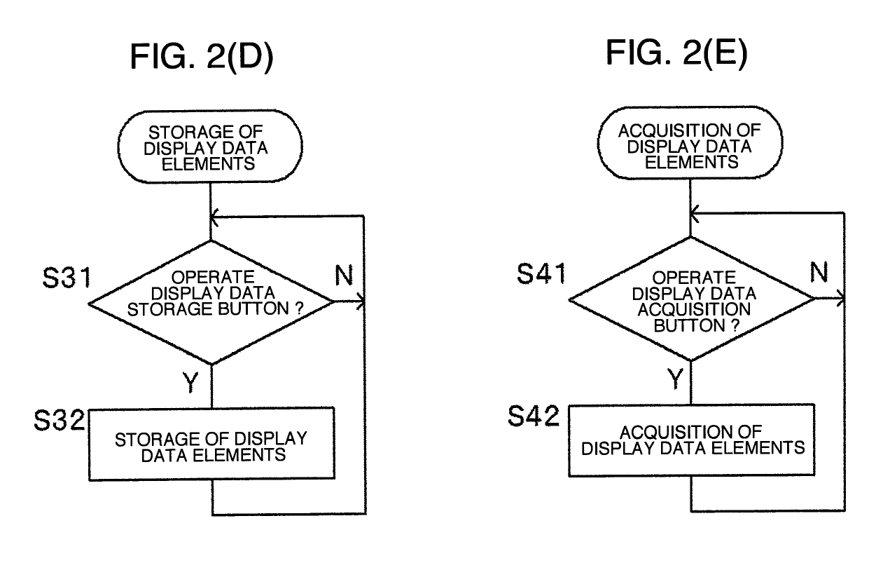

FIGS. 2(A) to 2(E) are flow charts each showing an operation of the operation-monitor station 3.

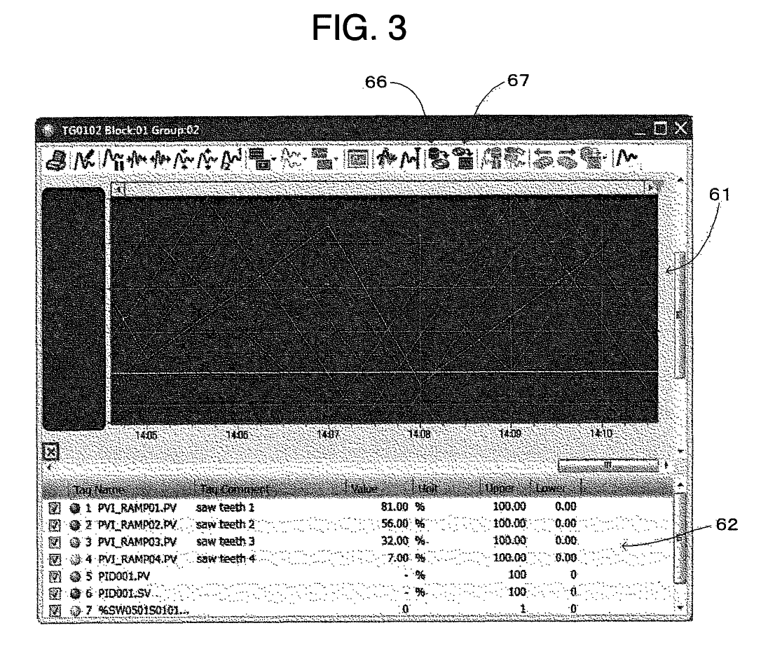

In FIG. 2(A), steps S1 to S3 show display processing on the trend screen. FIG. 3 shows the trend screen displayed on the display screen 6.

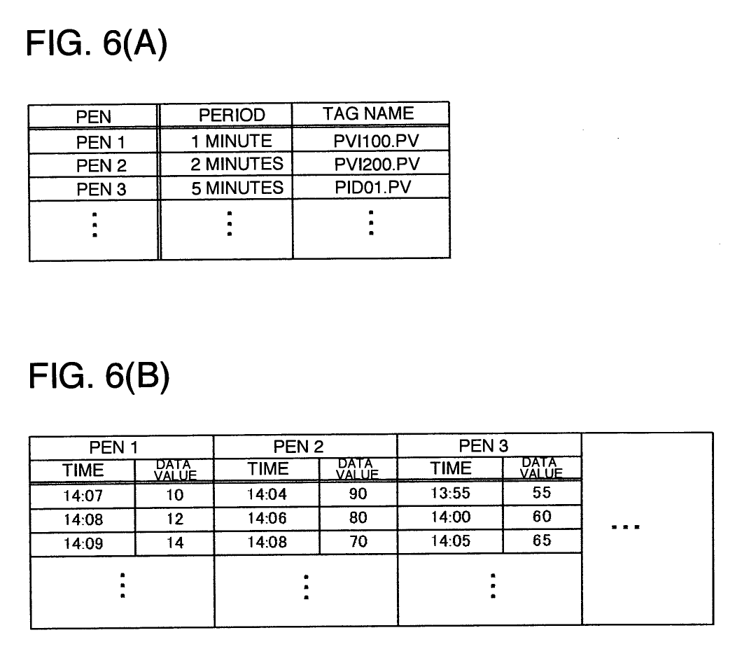

In the step S1, the display unit 34 acquires the present pen-allocation information on the basis of the operation for the selective operation acceptance unit 33. The pen-allocation information is prepared so as to correspond to pens and tag names, on the trend screen, respectively, and the number of the pens is 8 lengths at the maximum. FIG. 6(A) is a view showing data makeup of the pen-allocation information. As shown in FIG. 6(A), the pen-allocation information is information wherein a collection period of a field data element and a tag name of the relevant field data element are related to the respective pens. A plurality of periods {1 minute, 2 minutes, and so forth, in FIG. 6(A)} are mixedly present in the collection period of a field data element, and trend graphs of field data elements collected in different collection periods, respectively, can be displayed on the same trend screen.

Next, in the step S2, the trend data collection server 32 acquires trend data elements with tag names corresponding to respective pens from the trend data storage 31 on the basis of the present pen-allocation information to be thereby delivered to the display unit 34.

Further, in the step S3, the display unit 34 renders the trend data elements acquired from the trend data storage 31 according to respective pens corresponding thereto on the display screen 6, whereupon operation reverts to the step S1. By so doing, the trend data elements with the tags presently allocated to respective pens are displayed as trend graphs in a region 61 in real time in accordance with the pen-allocation information, as shown in FIG. 3. Further, present values of field data elements with tags allocated to the respective pens are numerically displayed in a region 62.

In FIG. 2(B), steps S11 to S12 show pen-allocation processing using a launcher screen.

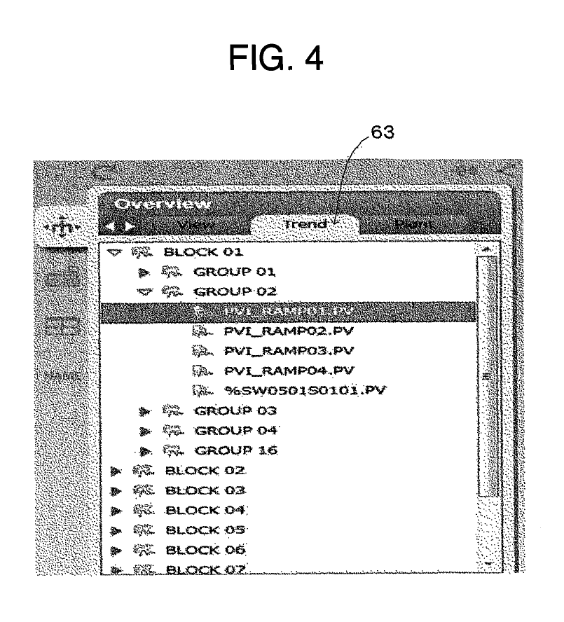

FIG. 4 is a view showing a launcher screen displayed on the display screen 6. A list of the tag names of the trend data element stored in the trend data storage 31 is expanded to be displayed on the launcher screen. In accordance with the definition prepared by use of the definition builder 51, and stored in the definition storage 52, the tag names are sequentially and hierarchically organized on the basis of a block and a group to be reflected in the launcher screen. The blocks each are related to the collection periods of the field data elements in the trend data collection server 32 and the collection periods of the field data elements are identical to each other in the same block.

A user can open a tab 63 for operation on the trend screen by operating the launcher screen, and can display the tag name of an optional trend data element on the screen by sequentially designating and expanding blocks and groups. With an example shown in FIG. 4, there is shown a screen state wherein the blocks and groups are sequentially expanded in the order of “BLOCK 01”→“GROUP 02”. If a specific tag name (for example, [PVI_RAMP01. PV]) that is expanded and displayed is selected to be dragged and dropped in the region 61 of the trend screen (FIG. 3) concurrently displayed on the display screen 6, this will enable a trend data element corresponding to the specific tag name to be allocated to a specific pen. Thus, a trend data element can be allocated to a pen by a simple operation.

In the step S11, the selective operation acceptance unit 33 determines whether or not a trend data element has been allocated to a pen by executing the operation with the use of the launcher screen, as above, whereupon the operation proceeds to the step S12 after waiting for affirmative determination.

In the step S12, the selective operation acceptance unit 33 causes the operation for the launcher screen, described as above, to be reflected in the present pen-allocation information, and stores the present pen-allocation information in the pen-allocation information storage 36, whereupon the operation reverts to the step S11. Such a change in the pen-allocation information is reflected in display on the trend screen (FIG. 3) in real time.

Thus, the user can combine optional tags belonging to an optional block (collection period) with each other by use of the launcher screen so as to be allocated to respective pens, so that trend data elements having a plurality of collection periods mixedly present therein can be displayed on the same trend screen in real time.

In FIG. 2(C), steps S21 to 23 show processing for change in pen-allocation by use of a pen-allocation change screen.

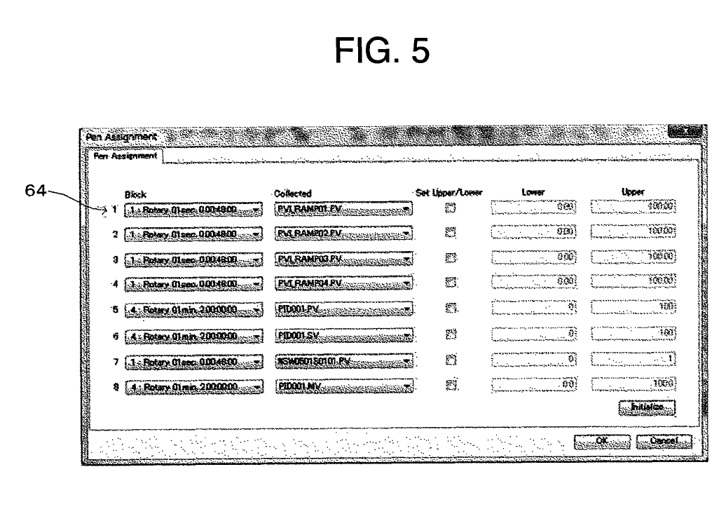

FIG. 5 is view showing the pen-allocation change screen displayed on the display screen 6. In the pen-allocation change screen, there are provided 8 regions (including a region 64, and so forth) for selecting collection periods, and tag names, respectively. If a block (collection period) is selected in each of the regions, this will enable an optional tag name to be designated out of the list of the tag names included in the block. By so doing, the trend data element can be allocated to the 8 lengths of the pens at the maximum, respectively. For example, in the case of FIG. 5, a specific tag name [PVI_RAMP01. PV] is selected in the region 64, and a trend data element corresponding thereto is allocated to a specific pen. Further, the present pen-allocation information may be reflected as the case of default of the pen-allocation change screen.

In the step 21 in FIG. 2(C), the operation waits for an operation to call the pen-allocation change screen, executed by the selective operation acceptance unit 33, thereby proceeding to the step S22.

In the step S22, the display unit 34 calls the pen-allocation change screen to be displayed on the display screen 6.

Next, in the step S23, the operation against the pen-allocation change screen, described as above, determines whether or not new allocation of a trend data element to a pen has been executed, thereby proceeding to the step S24 if determination is affirmative while reverting to the step S21 if determination is negative.

In step S24, the operation against the pen-allocation change screen, described as above, is reflected in the present pen-allocation information, and the present pen-allocation information is stored in the pen-allocation information storage 36, thereby reverting to the step S21. Such a change in the pen-allocation information is reflected in display on the trend screen (FIG. 3) in real time.

Thus, the user can combine optional tags belonging to an optional block (collection period) with each other by use of the pen-allocation change screen to be thereby allocated to a pen, so that trend data elements each having a plurality of collection periods mixedly present therein can be displayed on the same trend screen in real time.

In FIG. 2(D), steps S31 to S32 show display data storage processing.

When the user wants to store display data displayed on the trend screen (FIG. 3), the user can store the display data presently displayed on the trend screen in the display data storage 35 by clicking a display data storage button 66 on the trend screen.

In the step S31 in FIG. 2(D), the operation proceed to the step S32 after waiting for the display data storage button 66 (FIG. 3) being clicked. In the step S32, the display unit 34 stores the display data presently displayed on the trend screen in the display data storage 35, thereby reverting to the step S31.

FIG. 6(B) is a view showing data makeup of display data. As shown in FIG. 6(B), the display data are data wherein time and a data value are related to each other on a pen-by-pen basis

In FIG. 2(E), steps S41 to S42 show processing for acquisition of display data elements as stored.

When the display data elements stored in the display data storage 35 need be displayed on the trend screen, the user clicks a stored data acquisition button 67 (FIG. 3) on the trend screen, whereupon the display data elements stored in the display data storage 35 can be displayed as trend graphs on the trend screen.

In the step S41 shown in FIG. 2(E), the operation proceeds to the step S42 after waiting for the stored data acquisition button 67 (FIG. 3) being clicked. In the step S42, the display unit 34 acquires the display data elements stored in the display data storage 35, displaying those display data elements as the trend graphs on the trend screen, whereupon the operation reverts to the step S41.

Thus, it is possible to store display data in block on the trend screen, and to make use of the display data as stored.

As described in the foregoing, with the field data display apparatus according to the invention, it is possible to accept an operation for selecting trend data elements, the trend data elements each having a plurality of collection periods differing from each other, mixedly present in the collection period of the field data element, and to display a plurality of the trend data elements as selected on the same trend screen, so that the field data elements differing in collection periods can be freely combined with each other to thereby effect trend display.

It is to be pointed out that an application scope of the present invention is not limited to the embodiment described in the foregoing. The present invention can be widely applied to a field data display apparatus for displaying a plurality of field data elements on the same trend screen, and a method for displaying field data.

1. A field data display apparatus for displaying a plurality of field data elements on the same trend screen, said apparatus comprising:
storage means for collecting field data elements in predetermined periods, respectively, to be stored as a trend data element;
selective operation acceptance means for accepting an operation for selecting a plurality of trend data elements from among the trend data elements stored in the storage means; and display means for displaying the plurality of the trend data elements as selected through the intermediary of the selective operation acceptance means on the same trend screen; wherein the selective operation acceptance means accepts an operation for selecting trend data elements, the trend data elements each having a plurality of collection periods differing from each other, mixedly present in the collection period of the field data element.

2. The field data display apparatus according to claim 1, wherein the selective operation acceptance means accepts an operation for classifying the trend data elements on a period-by-period basis to be displayed on a screen, the operation being executed on the screen.

3. The field data display apparatus according to claim 1, further comprises pen-allocation information memory means for storing the plurality of the trend data elements as selected through the intermediary of the selective operation acceptance means, in reusable state.

4. The field data display apparatus according to claim 1, further comprises display data memory means for storing display data elements on a screen, displayed by the display means, in a state as to be re-displayed by the display means.

5. A method for displaying field data in a method for displaying a plurality of field data elements on the same trend screen, said method comprising the step of collecting field data elements in predetermined periods, respectively, to be stored as a trend data element, the step of accepting an operation for selecting a plurality of trend data elements from among the trend data elements stored in the preceding step for storing, and the step of displaying the plurality of the trend data elements as selected through the intermediary of the step of accepting the operation, on the same trend screen, wherein an operation for selecting trend data elements, the trend data elements each having a plurality of collection periods differing from each other, mixedly present in the collection period of the field data element, is accepted.

6. The field data display apparatus according to claim 2, further comprises pen-allocation information memory means for storing the plurality of the trend data elements as selected through the intermediary of the selective operation acceptance means, in reusable state.

7. The field data display apparatus according to claim 2, further comprises display data memory means for storing display data elements on a screen, displayed by the display means, in a state as to be re-displayed by the display means.

8. The field data display apparatus according to claim 3, further comprises display data memory means for storing display data elements on a screen, displayed by the display means, in a state as to be re-displayed by the display means.

9. The field data display apparatus according to claim 6, further comprises display data memory means for storing display data elements on a screen, displayed by the display means, in a state as to be re-displayed by the display means.
